(19) United States
(12) Patent Application Publication
(10) Pub. No.: US 2025/0337497 A1
(43) Pub. Date: Oct. 30, 2025

(54) PHOTONIC MULTI-BAND, MULTI-FREQUENCY RADAR

(71) Applicant: OEWAVES, INC., Pasadena, CA (US)

(72) Inventors: Lute MALEKI, Pasadena, CA (US); Danny ELIYAHU, Pasadena, CA (US); Scott SINGER, Pasadena, CA (US)

(21) Appl. No.: 19/188,889

(22) Filed: Apr. 24, 2025

Related U.S. Application Data
(60) Provisional application No. 63/639,823, filed on Apr. 29, 2024.

(51) Int. Cl. H04B 10/516; G01S 7/282; G01S 7/288; G01S 7/35

(52) U.S. Cl. CPC H04B 10/516; G01S 7/282; G01S 7/288; G01S 7/352

(57) ABSTRACT

A multi-frequency photonic radar is configured to provide three or more radar frequencies simultaneously or separately. The radar devices and techniques described herein enable the processing using any desired frequency (limited only by the bandwidth of photodetectors in the radar) with wide tunability from, e.g., 1 GHz to the limit of the bandwidth of the photodetectors (e.g., 110 GHz, 270 GHz, etc.), using either pulsed or continuous frequency modulated waveforms. The radar device may be configured as a photonic integrated circuit (PIC).

### PRIORITY CLAIM AND CROSS-REFERENCE TO RELATED APPLICATION

This patent document claims the priority of U.S. Provisional Application No. 63/639,823, entitled “PHOTONIC MULTI-BAND, MULTI-FREQUENCY RADAR,” filed on Apr. 29, 2024, the entire disclosure of which is incorporated by reference herein.

### FIELD OF THE DISCLOSURE

Various aspects of the disclosure relate to photonic systems and in particular to photonic radar systems.

### BACKGROUND

Multi-frequency, multi-band radar includes systems that operate with the simultaneous or switched use of multiple frequencies to obtain information not accessible with a single-frequency radar. These systems are particularly useful for remote sensing and climate studies to attain, for example, information about clouds and their water content and precipitation. Different frequencies interact with atmospheric components, such as clouds, precipitation, and aerosols, in unique ways. By utilizing multiple frequencies, radar systems can capture a broader range of information about these components, including their size distribution, composition, and vertical structure. This improves the sensitivity of radar measurements and enables more comprehensive studies of atmospheric processes.

Most simultaneous or switched multi-frequency band radar systems are generally limited to the use of two radar frequencies. This is because a practical realization of these radar systems often requires multiple local oscillator (LO) frequencies, with several stages of frequency up/down conversion. For this reason, realization of these systems is particularly challenging when the frequency of radar is large and thus several stages of up/down conversion and LO's are required. These same limitations can also limit the bandwidth of the radar. For example, a weather radar capable of providing information for rain and snow may require a differential radar system that operates in the mm-wave (mmW) band, while a system providing information for rain may operate at a lower frequency.

A new approach is needed to address these and other issues.

### SUMMARY

In one aspect, a simultaneous or switched multi-frequency, multi-band radar device is provided wherein the device is configured with photonic components. For example, a radar device can be configured as a photonic circuit that includes: a plurality of coherent optical sources; and a plurality of photonic optical components configured to receive coherent optical signals from the plurality of coherent optical sources to provide an output radar signal modulated by a radar waveform for transmission by an antenna, the output radar signal configurable to provide at least three different radar frequencies.

In another aspect, a photonic device for use with pulsed waveforms is provided. The device includes: a first coherent optical source configured to generate a first coherent optical signal at a first wavelength that is fixed; a transmit modulator configured to modulate the first coherent optical signal using a radar waveform to produce a modulated signal with one or more modulated optical sidebands; an optical filter configured to filter the modulated optical signal to produce a single modulated sideband; a second coherent optical source configured to generate a second coherent optical signal at a second tunable wavelength, different from the first wavelength; a third coherent optical source configured to generate a third coherent optical signal at a third tunable wavelength, different from the first wavelength and the second wavelength; a fourth coherent optical source configured to generate a fourth coherent optical signal at a fourth tunable wavelength, different from the first wavelength, the second wavelength and the third wavelength; an optical coupler configured to combine the single modulated sideband and the second, third and fourth coherent optical signals into a combined coherent optical signal modulated by the radar waveform; and a transmit photodetector configured to convert the combined coherent optical signal into an output radar signal modulated by the radar waveform for transmission by an antenna, wherein the single modulated sideband generates a beat signal with the second and third coherent optical signals on the transmit photodetector.

Additionally, the photonic device for use with pulsed waveforms may include: a receive optical modulator configured to receive an unmodulated version of the first coherent optical signal and to modulate it with a receive modulator using as input the reflected radar signal (echo) obtained from the antenna to provide a modulated optical signal; an optical splitter configured to split the modulated optical input signal into first, second, and third intermediate optical signals; a first optical combiner for combining the second coherent optical signal with the first intermediate optical signal to provide a first combined intermediate optical signal; a second optical combiner for combining the third coherent optical signal with the second intermediate optical signal to provide a second combined intermediate optical signal; a third optical combiner for combining the fourth coherent optical signal with the third intermediate optical signal to provide a third combined intermediate optical signal; a first receive photodetector configured to convert the first combined intermediate optical signal into a first radar intermediate frequency signal; a second receive photodetector configured to convert the second combined intermediate optical signal into a second radar intermediate frequency signal; and a third receive photodetector configured to convert the third combined intermediate optical signal into a third radar intermediate frequency signal. In other examples, additional coherent optical sources may be provided at additional wavelengths that differ from the first, second, third, and fourth wavelengths.

In yet another aspect, a frequency-modulated continuous wave (FMCW) photonic device is provided. The device includes: a first coherent optical source configured to generate a first coherent optical signal at a first wavelength that is fixed; a transmit modulator configured to modulate the first coherent optical signal using a radar waveform to produce a modulated signal; a second coherent optical source configured to generate a second tunable coherent optical signal at a second wavelength, different from the first wavelength; a third tunable coherent optical source configured to generate a third coherent optical signal at a third wavelength, different from the first wavelength and the second wavelength; a fourth tunable coherent optical source configured to generate a fourth coherent optical signal at a fourth wavelength, different from the first wavelength, the second wavelength and the third wavelength; one or more switches for switching one or more of the second, third and fourth coherent optical signals on or off; an optical coupler configured to combine the modulated signal with one or more of the second, third, and fourth coherent optical signals into a combined coherent optical signal modulated by the radar waveform; an optical splitter configured to split the combined coherent optical signal into an output optical signal and a feedback optical signal; and a transmit photodetector configured to convert the optical signal into an output radar signal modulated by the radar waveform for transmission by an antenna, wherein the modulated signal generates a beat signal with one of more of the second, third, and fourth coherent optical signals on the transmit photodetector.

Additionally, the FMCW photonic device may include: a receive optical modulator configured to receive the feedback optical signal and to modulate the feedback optical signal using an input reflected radar signal (echo) obtained from the antenna to provide a modulated optical input signal; a receive photodetector configured to convert the modulated optical input signal into a radar intermediate frequency signal having multiple frequency components. In other examples, additional coherent optical sources may be provided at additional wavelengths that differ from the first, second, third and fourth wavelengths.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

FIG. 1 is a block diagram of an exemplary multi-frequency radar device configured with photonic components for use with pulsed signals.

FIG. 2 is a block diagram of an exemplary multi-frequency radar device configured with photonic components for use with FMCW signals.

FIG. 3 is a block diagram of another exemplary multi-frequency radar device configured with photonic components.

FIG. 4 is a block diagram of an exemplary multi-frequency radar device configured with photonic components for use with pulsed signals.

FIG. 5 is a block diagram of another exemplary multi-frequency radar device configured with photonic components for use with FMCW signals.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure. In the figures, elements may each have a same reference number or a different reference number to suggest that the elements represented could be different and/or similar. However, an element may be flexible enough to have different implementations and work with some or all of the systems shown or described herein. The various elements shown in the figures may be the same or different and, which one is referred to as a first element and which is called a second element is arbitrary.

### Overview

As noted above, multi-frequency, multi-band radar use multiple frequencies simultaneously or separately to obtain information that is not accessible with a single-frequency radar. These types of systems are particularly useful for remote sensing and climate studies. Other applications of multi-frequency radar include: surveillance and reconnaissance for detection and tracking of moving targets, such as vehicles, aircraft, and ships, in different weather conditions; geological exploration for mapping subsurface features, detecting geological structures, and identifying mineral deposits; and meteorology.

Issues involving conventional multi-frequency, multi-band radar systems were discussed above. Herein, photonic components are employed to address these and other issues. In particular, techniques or schemes are disclosed herein whereby a multi-frequency photonic radar is configured to provide two or more frequencies simultaneously. The techniques described herein feature the use of any desired frequency (limited only by the bandwidth of the photodetectors and modulators used in the photonic system), wide tunability from, e.g., 1 GHz to the limit of the bandwidth of the detector and modulator, e.g., 110 GHz, 270 GHz, etc., and the capability to operate with pulsed or frequency modulated waveforms, including simple pulses, chirped pulses, and triangle or sawtooth or similar waveforms. Photonic components are known for their low loss, wide bandwidth, and small size. Thus, their use in the realization of sensors such as radar is particularly beneficial.

### Exemplary Methods and Apparatus

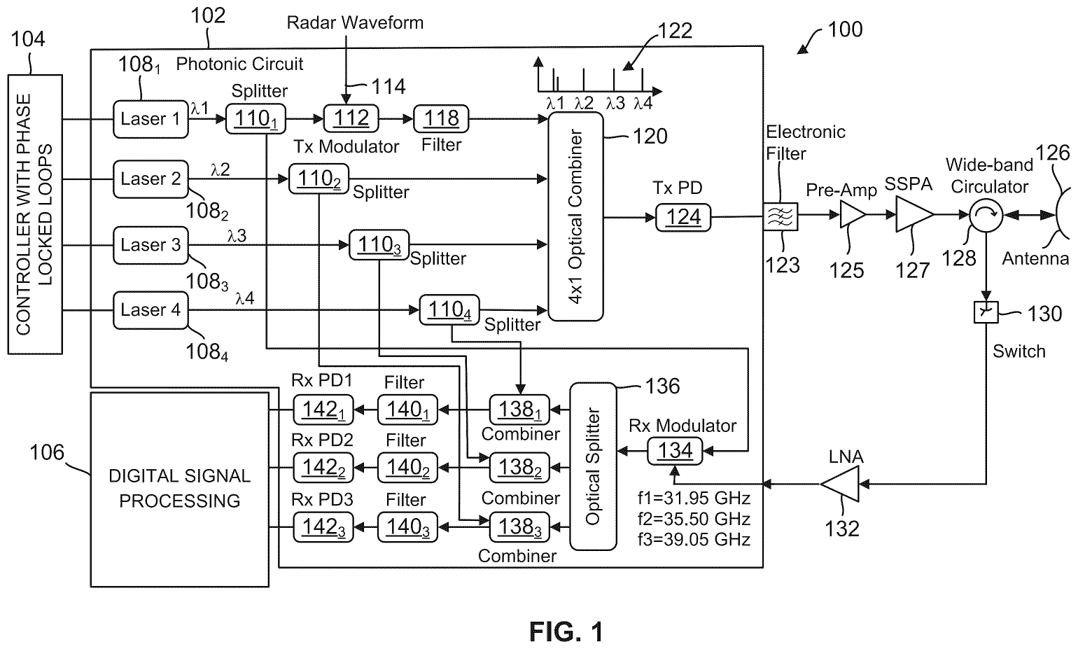

FIG. 1 is a block diagram of a photonic radar system 100 configured to provide three simultaneous frequencies. The photonic elements are formed on a photonic circuit 102. An electronics front end includes a controller 104 and a digital processing system 106 that are external to the photonic circuit 104. The photonic radar system 100 includes four lasers (108₁, 108₂, 108₃, and 108₄) and is capable of generating three different, simultaneous radar frequencies. For more than three frequencies, the same approach can be applied with more lasers, filters, splitters/combiners, as appropriate. For two frequencies, only three lasers are instead used with fewer filters, splitters/combines, again as appropriate.

The operation of the radar is as follows: the four lasers (108₁, 108₂, 108₃, and 108₄) each provide emission at a respective wavelength λ1, λ2, λ3, and λ4 under the control of the controller 104 that includes phased-locked loops (PLLs) or similar techniques for locking the wavelengths of each of the four lasers. The wavelength (or corresponding frequency) of laser 1 (108₁) is fixed at a first wavelength λ1 (or corresponding frequency). The wavelength (or corresponding frequency) of laser 2 (108₂) is tunable and can be locked at a second wavelength λ2 (or corresponding frequency) that is different from the first wavelength λ1 (or corresponding frequency). The wavelength (or corresponding frequency) of laser 3 (108₃) is tunable and can be locked at a third wavelength λ3 (or corresponding frequency) that is different from the first and second wavelengths (or corresponding frequencies). The wavelength (or corresponding frequency) of laser 4 (108₄) is tunable and can be locked at a fourth wavelength λ4 (or corresponding frequency) that is different from the first, second, and third wavelengths (or corresponding frequencies). In an illustrative example, the difference of wavelengths (or corresponding frequencies) may be around 30 GHz or otherwise in the mmW band. In other examples, the difference of wavelengths (or corresponding frequencies) may be in the K band. In still other examples, the difference of wavelengths (or corresponding frequencies) may be, e.g., from 1 GHz to 110 GHz or larger.

An optical splitter is provided along each of the laser output signals for splitting off a version of the signals for processing by receive components, described below. That is, four optical splitters (110₁, 110₂, 110₃, and 110₄) are provided as shown. A transmit (Tx) modulator 112 modulates the laser 1 signal with a radar waveform 114, which produces a set of modulated sidebands. An optical filter 118 operates to filter out all but one of the modulated sidebands, e.g., a selected upper sideband (which is selected by choosing the pass-through frequency of the optical filter). The modulated sideband is applied to a 4×1 optical combiner 120 along with the unmodulated signals from lasers 2, 3, and 4.

In FIG. 1, a graph 122 is shown above the 4×1 optical combiner 120, which shows λ1, λ2, λ3, and λ4 and also shows a sideband adjacent to λ1. This is the modulated sideband that has passed through the optical filter 118. Note that, although λ1 is shown in the graph, λ1 is filtered out by the optical filter 118 and only the selected optical sideband of the laser 1 signal reaches the optical combining component or combiner 120 (along with the laser 2, 3, and 4 signals). The combined optical output signal from the 4×1 optical filter is applied to a transmit (Tx) photodetector 124.

With this configuration, the frequency difference between the four lasers (108₁, 108₂, 108₃, and 108₄) provides the three carriers, and the beat of frequencies of tunable lasers 2, 3, and 4 lasers (108₂, 108₃, and 108₄) with the upper sideband of (the fixed frequency) laser 1 (108₁) is used to generate the radar signal at the output of the transmit PD 124. That is, the frequency differences between the optical signals applied to the transmit PD 124 create multiple beat frequencies on the photodetector 124, which in turn generates corresponding RF output signals at different frequencies, thus converting the optical signals applied to the photodetector 124 to output RF signals. A radar waveform 114 of interest is modulated on laser 1 lasers (108₁) using the Tx modulator 112. This may be achieved by placing a modulator on the path of emission of laser 1, as shown. In other examples, the current or any other tunable parameter of laser 1 lasers (108₁) may be modulated.

In the configuration shown, a pulsed scheme is provided whereby pulses (with or without chirps) intended for each carrier frequency are applied to the Tx modulator 112. Each of lasers 2, 3, and 4 lasers (108₂, 108₃, and 108₄) may be switched (using switches not shown) before optical combining so that at any time only one of the generated carriers is transmitted.

The output radar signal is sent through an optional electronic filter 123 to an antenna 126 via a pre-amp 125, a solid state phased array (SSPA) 127, and a wide-band circulator 128. The antenna 126 transmits the radar signal and receives a reflected signal (e.g., from an object or a layer of clouds). The return radar signal is also passed through the wide-band circulator 128 (for a monostatic radar) or directly from the receive antenna 126 and is routed to the receiver portion of the photonic device. As shown, a switch 130 might be provided along the return path along with RF amplifier 132, e.g., a low noise amplifier (LNA) 132.

On the receiver part of the photonic device 100, the unmodulated output of laser 1 (108₁) is introduced to a receive (Rx) optical modulator 134 that also receives the return (reflected) RF signal. In the example of FIG. 1, the return radar signal has frequencies at 31.95 GHz, 35.50 GHz, and 39.05 GHz, which arise from the choice of frequencies of lasers 1-4, but these frequencies are merely exemplary. The output of the Rx modulator 134 is split into three branches by an optical splitter 136, each of which is mixed with the outputs of lasers 2, 3, and 4 via a corresponding combiner (138₁, 128₂, and 138₃), each followed by a corresponding optical filter (140₁, 140₂, and 140₃) and a corresponding low bandwidth photodetector (Rx PD1, Rx PD2, and Rx PD3, also denoted in the figure as 142₁, 142₂, and 142₃). These low bandwidth photodetectors function as a mixer and a low-pass filter and output only the received signals at the intermediate frequencies (IF) to the digital signal processing system 106 that digitizes and processes the signals to, e.g., detect objects or parameters of interest to provide data products.

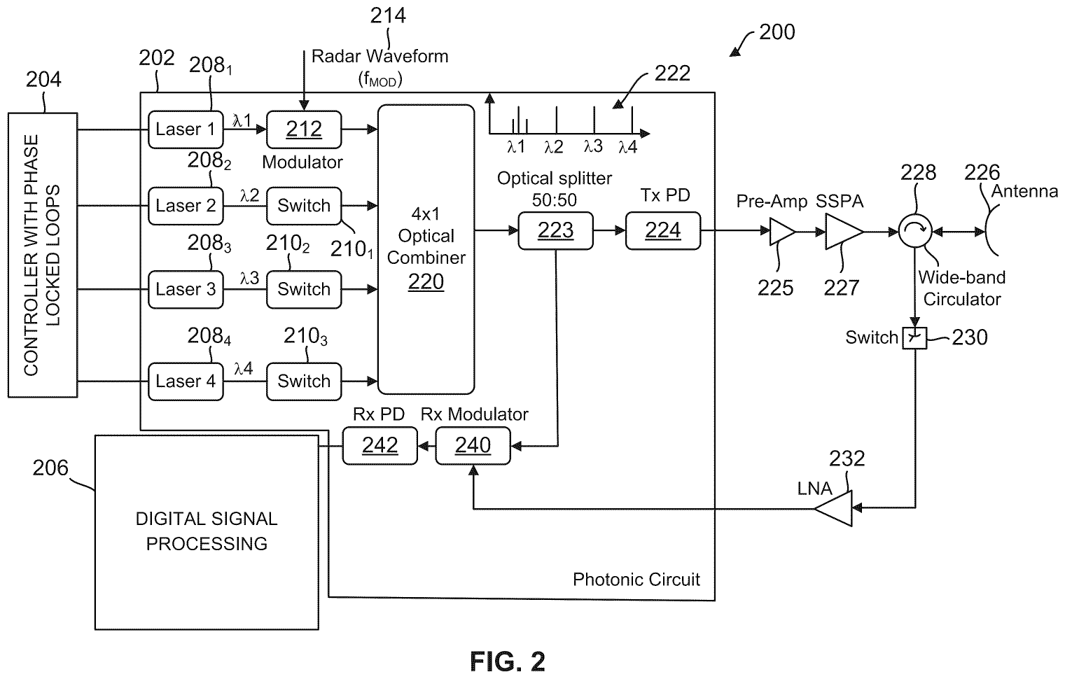

A similar technique or scheme can support a multi-band, multi-wavelength photonic radar in a frequency-modulated continuous wave (FMCW) configuration, which may be used in a variety of applications including atmospheric research, multi-function, and autonomous vehicles. The scheme is shown in FIG. 2.

FIG. 2 is a block diagram of an FMCW photonic radar system 200 configured to generate three different frequencies and to switch between them. The exemplary system includes four lasers (208₁, 108₂, 208₃, and 208₄) and is capable of generating three different radar frequencies. For more than three frequencies, the same approach can be applied with more lasers, switches, etc., as appropriate. For two frequencies, only three lasers are instead used with fewer switches, etc., again as appropriate.

The operation of the FMCW radar is as follows: four lasers (208₁, 108₂, 208₃, and 208₄) each provide emission at λ1, λ2, λ3, and λ4 under the controller of a controller 204 that includes PLLs for locking the wavelengths of the lasers. As with the device 100 of FIG. 1, the wavelength (or corresponding frequency) of laser (208₁) 1 is fixed at a first wavelength λ1 (frequency); the wavelength (or corresponding frequency) of laser 2 (208₂) is locked at a second wavelength λ2 (or corresponding frequency) that is different from the first wavelength (frequency); the wavelength (or corresponding frequency) of laser 3 (208₃) is locked at a third wavelength λ3 (or corresponding frequency) that is different from the first and second wavelengths (frequencies); and the wavelength (or corresponding frequency) of laser 4 (208₄) is locked at a fourth wavelength λ4 (or corresponding frequency) that is different from the first, second, and third wavelengths (frequencies).

A transmit (Tx) modulator 212 modulates the laser 1 signal with a radar waveform 214 of interest (e.g., at f_{MOD}), which produces a set of modulated signals. Three switches (210₁, 210₂, and 210₃) are used to selectively switch the laser 2, 3, and 4 signals on or off so that only one of those signals passes at any given time. The entire modulated laser 1 signal is applied to a 4×1 optical combining component or combiner 220 along with the selected unmodulated signal from either laser 2, 3, or 4. (In other examples, the switches may be set to permit two or more of the signals from lasers 2, 3, and 4 to pass simultaneously, or the switches can be omitted entirely.)

In FIG. 2, a graph 222 is shown near the 4×1 optical combining component or combiner 220, which shows λ1, λ2, λ3, and λ4 and also shows two exemplary sidebands adjacent to λ1. That is, unlike the device of FIG. 1, which includes an optical filter 118 configured to obtain only one sideband from laser 1, the device of FIG. 2 does not include a corresponding filter, thus permitting all of the components of the modulated laser 1 signal to reach the 4×1 optical combiner 220. Note that, although only two exemplary laser 1 sidebands are shown in the graph within FIG. 2, there may be additional sidebands that are not shown. The combined optical output signal from the 4×1 optical combiner 220 is applied to a 50:50 optical splitter 223 and then to a transmit (Tx) photodetector 224. With this configuration, the modulated components (or tones) of laser 1 and the selected other laser (e.g., laser 2, 3, or 4) beat on the Tx PD 224 to generate an RF radar signal at the output of the transmit PD 224. (In other examples, the switches 210₁, 210₂, and 210₃ are set to permit two or more of the signals from lasers 2, 3, and 4 to pass simultaneously to provide more beat signals.)

The radar waveform of interest is modulated on laser 1 using the Tx modulator 212. The output radar signal is sent to an antenna 226 via a pre-amp 225, a solid state phased array (SSPA) 227, and a wide-band circulator 228. The antenna 226 transmits the radar signal and receives a reflected signal (e.g., from an object or a layer of clouds). The return radar signal is also passed through the wide-band circulator 228 (for a monostatic radar; otherwise directly from the receive antenna 226) and is routed to the receiver portion of the photonic device 202. As shown, a switch 230 might be provided along the return path along with an LNA 232. (Note that an electronic filter such as filter 123 of FIG. 1 could also be used in the embodiment on FIG. 2, though such an electronic filter is not needed in either embodiment.)

On the receiver part of the photonic device, the split-off portion of the combined optical beam (obtained from the optical splitter) is introduced to a receive (Rx) optical modulator 240 that also receives the return (reflected) RF signal. Although not shown in FIG. 2, the return radar signal may have frequencies such as 31.95 GHz, 35.50 GHz, and 39.05 GHz, depending upon the choice of frequencies of lasers 1-4, and the particular lasers that are selected via the switches, but these frequencies are again merely exemplary. The output of the Rx modulator 240 is applied to a photodetector (Rx PD) 242, which acts as a mixer and a low-pass filter and outputs a received signal at an intermediate frequency (IF) to a digital signal processing system 206 that digitizes and processes the signals to, e.g., detect objects or parameters of interest to provide data products.

The multi-frequency FMCW photonic radar 200 of FIG. 2 may be used in many applications such as autonomous vehicles. It is particularly useful in rain, fog, snow, and any combination thereof. It can also be used in imaging for higher-resolution applications. As noted, there are differences between the FMCW configuration of FIG. 2 and the pulsed configuration of FIG. 1. In the FMCW radar of FIG. 2, the optical filter in the transmit path and the three optical filters in the receive path are not used as in FIG. 1. The switches that are shown in FIG. 2 are not needed if all carriers are used simultaneously. The receiver PD (Rx PD) has a small bandwidth corresponding to the maximum range. The Doppler velocity of an object may also be directly obtained with this configuration.

Note that for both configurations discussed herein, it is possible to operate the photonic radar by varying the wavelength (or corresponding frequency) of any (or all) of the lasers to achieve a bandwidth variable around a frequency of operation. Tuning and/or switching of the wavelength of lasers also allows agile operation of the radar, i.e. allowing a fast change of the wavelength to rapidly change the value of the transmit frequency generated by any of the 1+n (n=2, 3, 4) lasers.

Any frequencies included in the figures are notional. These frequencies may have any value up to the bandwidth of the transmit photodetector and the receive modulator. As such, current devices can support any band up to sub-THz frequency. With the advent of higher bandwidth photodetectors and modulators, this range will increase accordingly. This architecture may be implemented with discrete components, micro-photonic components, and photonic integrated circuits (PICs), including heterogeneously integrated PICs. The figures illustrate examples with four lasers, but as noted, more or fewer lasers may be employed. So long as at least three lasers are provided, at least two simultaneous radar frequencies can be generated. If only a single frequency is needed, only two lasers may be used, but then two simultaneous frequencies are not generated.

### Additional Examples and Embodiments

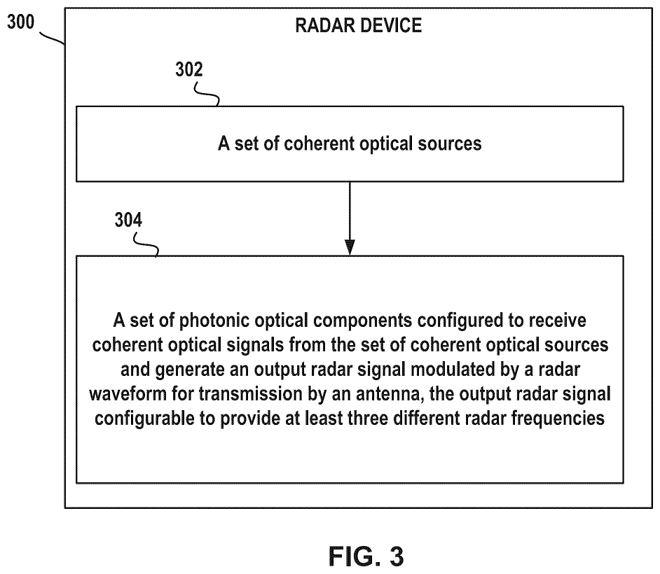

FIG. 3 illustrates a radar device 300 configured as a photonic circuit. The radar device 300 includes: a set or plurality of coherent optical sources 302; and a set or plurality of photonic optical components 304 configured to receive coherent optical signals from the set or plurality of coherent optical sources and generate an output radar signal modulated by a radar waveform for transmission by an antenna, the output radar signal configurable to provide at least three different radar frequencies.

In some aspects, the coherent optical sources 302 provide a means for generating a set or plurality of coherent optical signals. The photonic optical components 304 provide a means for receiving the coherent optical signals and generating an output radar signal modulated by a radar waveform for transmission by an antenna, with the output radar signal configurable to provide at least three different radar frequencies.

In some aspects, a method is provided that includes: generating a set or plurality of coherent optical signals using a set of coherent optical sources; and routing the set or plurality of coherent optical signals through a set or plurality of photonic optical components that are configured to receive coherent optical signals from the plurality of coherent optical sources and generate an output radar signal modulated by a radar waveform for transmission by an antenna, the output radar signal configurable to provide at least three different radar frequencies.

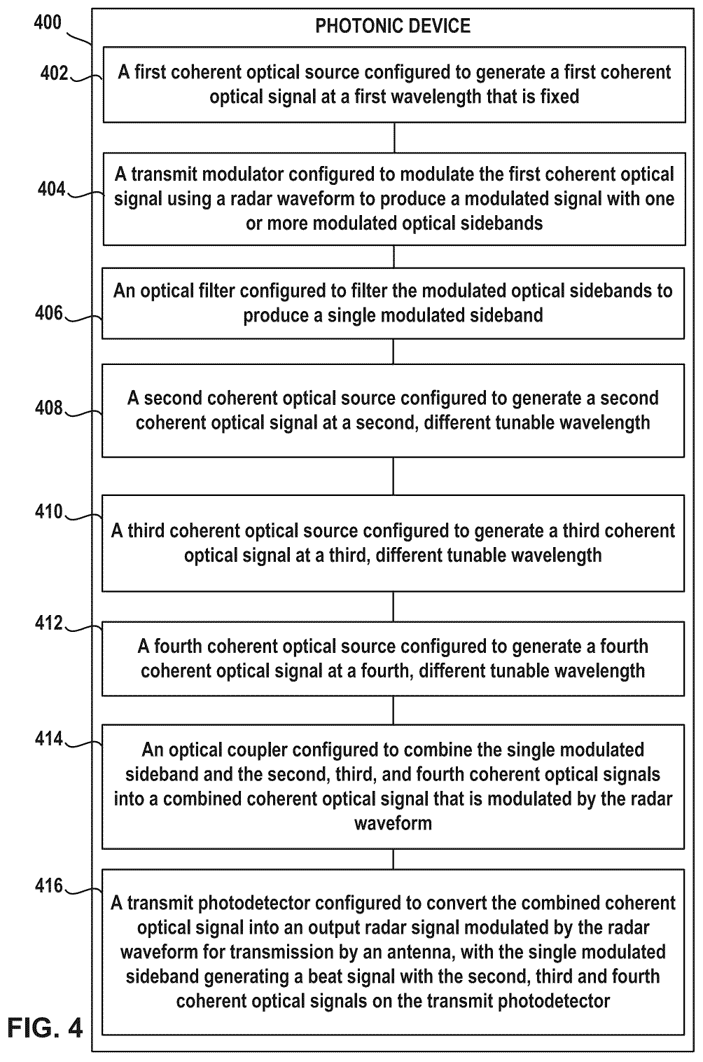

FIG. 4 illustrates a photonic device 400 for use with pulsed signals. The photonic device 400 includes a first coherent optical source 402 configured to generate a first coherent optical signal at a first wavelength that is fixed. A transmit modulator 404 is configured to modulate the first coherent optical signal using a radar waveform to produce a modulated signal with one or more modulated optical sidebands. An optical filter 406 is configured to filter the modulated optical sidebands to produce a single modulated sideband. A second coherent optical source 408 is configured to generate a second coherent optical signal at a second tunable wavelength, different from the first wavelength. A third coherent optical source 410 is configured to generate a third coherent optical signal at a third tunable wavelength, different from the first wavelength and the second wavelength. A fourth coherent optical source 412 is configured to generate a fourth coherent optical signal at a fourth tunable wavelength, different from the first, second, and third wavelengths. An optical coupler 414 is configured to combine the single modulated sideband and the second, third, and fourth coherent optical signals into a combined coherent optical signal modulated by the radar waveform. A transmit photodetector 416 is configured to convert the combined coherent optical signal into an output radar signal modulated by the radar waveform for transmission by an antenna, wherein the single modulated sideband generates a beat signal with the second, third and fourth coherent optical signals on the transmit photodetector.

In some aspects a method is provided that includes: generating a first coherent optical signal at a first wavelength that is fixed; modulating the first coherent optical signal using a radar waveform to produce a modulated signal with one or more modulated optical sidebands; filtering the modulated optical sidebands to produce a single modulated sideband; generating a second coherent optical signal at a second tunable wavelength, different from the first wavelength; generating a third coherent optical signal at a third tunable wavelength, different from the first wavelength and the second wavelength; generating a fourth coherent optical signal at a fourth tunable wavelength, different from the first, second, and third wavelengths; combining the single modulated sideband and the second, third, and fourth coherent optical signals into a combined coherent optical signal modulated by the radar waveform; and converting the combined coherent optical signal into an output radar signal modulated by the radar waveform for transmission by an antenna, wherein the single modulated sideband generates a beat signal with the second, third and fourth coherent optical signals on the transmit photodetector.

In some aspects an apparatus is provided that includes: means for generating a first coherent optical signal at a first wavelength that is fixed; means for modulating the first coherent optical signal using a radar waveform to produce a modulated signal with one or more modulated optical sidebands; means for filtering the modulated optical sidebands to produce a single modulated sideband; means for generating a second coherent optical signal at a second tunable wavelength, different from the first wavelength; means for generating a third coherent optical signal at a third tunable wavelength, different from the first wavelength and the second wavelength; means for generating a fourth coherent optical signal at a fourth tunable wavelength, different from the first, second, and third wavelengths; means for combining the single modulated sideband and the second, third, and fourth coherent optical signals into a combined coherent optical signal modulated by the radar waveform; and means for converting the combined coherent optical signal into an output radar signal modulated by the radar waveform for transmission by an antenna, wherein the single modulated sideband generates a beat signal with the second, third and fourth coherent optical signals on the transmit photodetector.

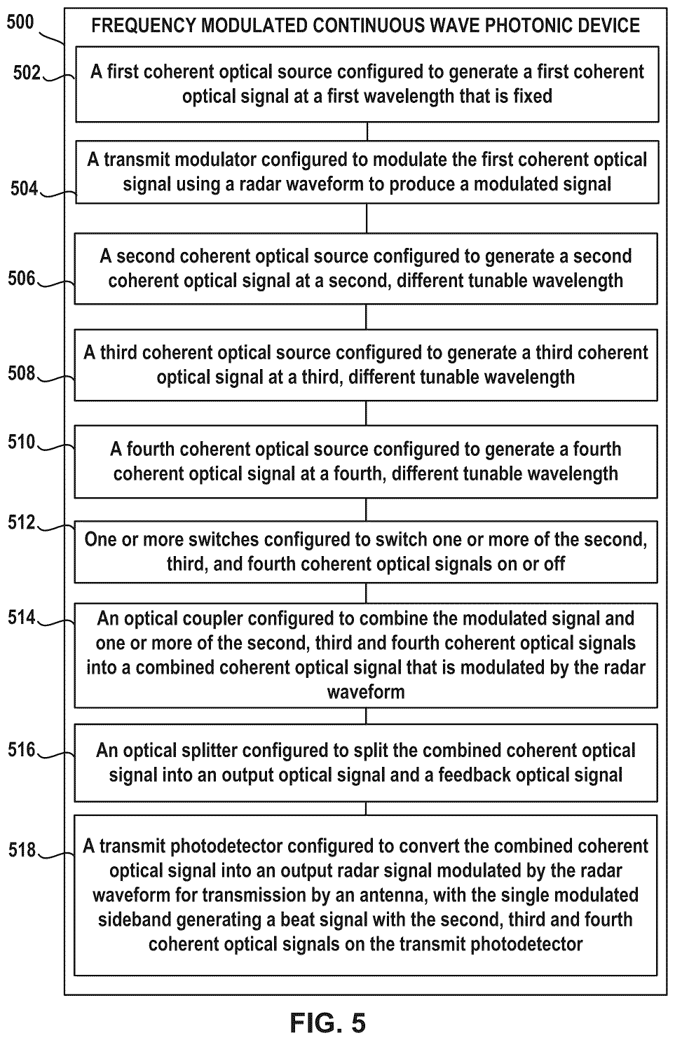

FIG. 5 illustrates an FMCW photonic device 500. The photonic device 500 includes a first coherent optical source 502 configured to generate a first coherent optical signal at a first wavelength that is fixed. A transmit modulator 504 is configured to modulate the first coherent optical signal using a radar waveform to produce a modulated signal. A second coherent optical source 506 is configured to generate a second coherent optical signal at a second tunable wavelength, different from the first wavelength. A third coherent optical source 508 is configured to generate a third coherent optical signal at a third tunable wavelength, different from the first wavelength and the second wavelength. A fourth coherent optical source 510 is configured to generate a fourth coherent optical signal at a fourth tunable wavelength, different from the first, second, and third wavelengths. One or more switches 512 are configured to switch one or more of the second, third, and fourth coherent optical signals on or off. An optical coupler 514 is configured to combine the modulated signal one or more of the second, third and fourth coherent optical signals into a combined coherent optical signal modulated by the radar waveform. An optical splitter 516 is configured to split the combined coherent optical signal into an output optical signal and a feedback optical signal. A transmit photodetector 518 is configured to convert the optical signal into an output radar signal modulated by the radar waveform for transmission by an antenna, wherein the modulated signal generates a beat signal with one or more of the second, third, and fourth coherent optical signals on the transmit photodetector.

In some aspects a method is provided that includes: generating a first coherent optical signal at a first wavelength that is fixed; modulating the first coherent optical signal using a radar waveform to produce a modulated signal; generating a second coherent optical signal at a second tunable wavelength, different from the first wavelength; generating a third coherent optical signal at a third tunable wavelength, different from the first wavelength and the second wavelength; generating a fourth coherent optical signal at a fourth tunable wavelength, different from the first, second, and third wavelengths; switching one or more of the second, third, and fourth coherent optical signals on or off; combining the modulated signal one or more of the second, third and fourth coherent optical signals into a combined coherent optical signal modulated by the radar waveform; splitting the combined coherent optical signal into an output optical signal and a feedback optical signal; and converting the optical signal into an output radar signal modulated by the radar waveform for transmission by an antenna, wherein the modulated signal generates a beat signal with one or more of the second, third, and fourth coherent optical signals on the transmit photodetector.

In some aspects an apparatus is provided that includes: means for generating a first coherent optical signal at a first wavelength that is fixed; means for modulating the first coherent optical signal using a radar waveform to produce a modulated signal; means for generating a second coherent optical signal at a second tunable wavelength, different from the first wavelength; means for generating a third coherent optical signal at a third tunable wavelength, different from the first wavelength and the second wavelength; means for generating a fourth coherent optical signal at a fourth tunable wavelength, different from the first, second, and third wavelengths; means for switching one or more of the second, third, and fourth coherent optical signals on or off; means for combining the modulated signal one or more of the second, third and fourth coherent optical signals into a combined coherent optical signal modulated by the radar waveform; means for splitting the combined coherent optical signal into an output optical signal and a feedback optical signal; and means for converting the optical signal into an output radar signal modulated by the radar waveform for transmission by an antenna, wherein the modulated signal generates a beat signal with one or more of the second, third, and fourth coherent optical signals on the transmit photodetector.

Note that the architectures/schemes shown in the various figures can also be applied to embodiments with three lasers (i.e., to generate two wavelengths/frequencies) rather than four lasers (i.e., to generate three wavelengths/frequencies). For example, within the embodiment of FIG. 1, Laser 4 (108₄) may be omitted along with the corresponding splitter (110₄), combiner (138₁), filter (140₁) and Rx PD (142₁) with the optical combiner 120 configured as a 3×1 combiner so that two wavelengths/frequencies are ultimately received and processed by the digital signal processor (DSP) 106. Within the embodiment of FIG. 2, Laser 4 (208₄) may be omitted along with the corresponding switch (210₃) with the optical combiner 220 configured as a 3×1 combiner so that two wavelengths/frequencies are ultimately received and processed by the DSP 206.

### Additional Aspects and Considerations

Note that one or more of the components, steps, features, and/or functions illustrated in FIGS. 1-5 may be rearranged and/or combined into a single component, step, feature or function or embodied in several components, steps, or functions. Additional elements, components, steps, and/or functions may also be added without departing from the invention.

The word “exemplary” is used herein to mean “serving as an example, instance, or illustration.” Any implementation or aspect described herein as “exemplary” is not necessarily to be construed as preferred or advantageous over other aspects of the disclosure. Likewise, an aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

The term “coupled” may mean that two or more elements are in direct physical or electrical contact. However, “coupled” may also mean that two or more elements are not in direct contact with each other, but yet still co-operate or interact with each other.

Not all components, features, structures, characteristics, etc. described and illustrated herein need be included in a particular aspect or aspects. If the specification states a component, feature, structure, or characteristic “may,” “might,” “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although some aspects have been described in reference to particular implementations, other implementations are possible. Additionally, the arrangement and/or order of elements or other features illustrated in the drawings and/or described herein need not be arranged in the particular way illustrated and described. Many other arrangements are possible according to some aspects.

Also, it is noted that the aspects of the present disclosure may be described as a process that is depicted as a flowchart, a flow diagram, a structure diagram, or a block diagram. Although a flow chart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A radar device configured as a photonic circuit comprising:
a plurality of coherent optical sources; and
a plurality of photonic optical components configured to receive coherent optical signals from the plurality of coherent optical sources and generate an output radar signal modulated by a radar waveform for transmission by an antenna, the output radar signal configurable to provide at least three different radar frequencies.

2. The radar device of claim 1 configured as a photonic integrated circuit (PIC).

3. A photonic device for use with pulsed signals, comprising:
a first coherent optical source configured to generate a first coherent optical signal at a first wavelength that is fixed;
a transmit modulator configured to modulate the first coherent optical signal using a radar waveform to produce a modulated signal with one or more modulated optical sidebands;
an optical filter configured to filter the modulated optical sidebands to produce a single modulated sideband;
a second coherent optical source configured to generate a second coherent optical signal at a second tunable wavelength, different from the first wavelength;
a third coherent optical source configured to generate a third coherent optical signal at a third tunable wavelength, different from the first wavelength and the second wavelength;
a fourth coherent optical source configured to generate a fourth coherent optical signal at a fourth tunable wavelength, different from the first, second, and third wavelengths;
an optical coupler configured to combine the single modulated sideband and the second, third, and fourth coherent optical signals into a combined coherent optical signal modulated by the radar waveform; and
a transmit photodetector configured to convert the combined coherent optical signal into an output radar signal modulated by the radar waveform for transmission by an antenna, wherein the single modulated sideband generates a beat signal with the second, third and fourth coherent optical signals on the transmit photodetector.

4. The photonic device of claim 3, further comprising:
a receive optical modulator configured to receive an unmodulated version of the first coherent optical signal and to modulate it with a receive modulator using as an input a reflected radar signal waveform obtained from the antenna to provide a modulated optical input signal;
an optical splitter configured to split the modulated optical input signal into first, second, and third intermediate optical signals;
a first optical combiner for combining the second coherent optical signal with the first intermediate optical signal to provide a first combined intermediate optical signal;
a second optical combiner for combining the third coherent optical signal with the second intermediate optical signal to provide a second combined intermediate optical signal;
a third optical combiner for combining the fourth coherent optical signal with the third intermediate optical signal to provide a third combined intermediate optical signal;
a first receive photodetector configured to convert the first combined intermediate optical signal into a first radar intermediate frequency signal (IF1); and
a second receive photodetector configured to convert the second combined intermediate optical signal into a second radar intermediate frequency signal (IF2);
a third receive photodetector configured to convert the third combined intermediate optical signal into a third radar intermediate frequency signal (IF3);
wherein the first, second, and third radar intermediate frequency signals are each at different wavelengths.

5. The photonic device of claim 4, wherein the receive photodetectors are configured as low bandwidth photodetectors to operate as mixers and low-pass filters.

6. A system comprising the photonic device of claim 3 and a controller that is configured to:
lock the first coherent optical source to a primary wavelength;
lock the second coherent optical source to a wavelength that is offset by a first amount from the primary wavelength;
lock the third coherent optical source to a wavelength that is offset by a second, different amount from the primary wavelength; and
lock the fourth coherent optical source to a wavelength that is offset by a third, different amount from the primary wavelength.

7. The photonic device of claim 3, wherein one or more of the coherent optical sources are selectively switched.

8. The photonic device of claim 3, further comprising an electrical filter to filter out noise from the output radar signal.

9. The photonic device of claim 3 configured as a photonic integrated circuit (PIC).

10. A frequency modulated continuous wave (FMCW) photonic device, comprising:
a first coherent optical source configured to generate a first coherent optical signal at a first wavelength that is fixed;
a transmit modulator configured to modulate the first coherent optical signal using a radar waveform to produce a modulated signal;
a second coherent optical source configured to generate a second coherent optical signal at a second tunable wavelength, different from the first wavelength;
a third coherent optical source configured to generate a third coherent optical signal at a third tunable wavelength, different from the first wavelength and the second wavelength;
a fourth coherent optical source configured to generate a fourth coherent optical signal at a fourth tunable wavelength, different from the first, second, and third wavelengths;
one or more switches configured to switch one or more of the second, third, and fourth coherent optical signals on or off;
an optical coupler configured to combine the modulated signal one or more of the second, third and fourth coherent optical signals into a combined coherent optical signal modulated by the radar waveform;
an optical splitter configured to split the combined coherent optical signal into an output optical signal and a feedback optical signal; and
a transmit photodetector configured to convert the optical signal into an output radar signal modulated by the radar waveform for transmission by an antenna, wherein the modulated signal generates a beat signal with one or more of the second, third, and fourth coherent optical signals on the transmit photodetector.

11. The photonic device of claim 10, further comprising:
a receive optical modulator configured to receive the feedback optical signal and to modulate the feedback optical signal using an input reflected radar signal waveform obtained from the antenna to provide a modulated optical input signal;
a receive photodetector configured to convert the modulated optical input signal into a radar intermediate frequency signal having multiple frequency components.

12. A system comprising the photonic device of claim 10 and a controller configured to:
lock the first coherent optical source to a primary wavelength;
lock the second coherent optical source to a wavelength that is offset by a first amount from the primary wavelength;
lock the third coherent optical source to a wavelength that is offset by a second, different amount from the primary wavelength; and
lock the fourth coherent optical source to a wavelength that is offset by a third, different amount from the primary wavelength.

13. The photonic device of claim 10 configured as a photonic integrated circuit (PIC).
